(19) United States
(12) Patent Application Publication
(10) Pub. No.: US 2024/0390786 A1
(43) Pub. Date: Nov. 28, 2024

(54) Cloud Game Queueing

(71) Applicant: Backbone Labs, Inc., Vancouver, WA (US)

(72) Inventors: Timothy Aldridge, Seattle, WA (US); Casey Chow, Seattle, WA (US); Christopher Blair, Brooklyn, NY (US); Rohan Kapur, San Francisco, CA (US); Shawn O'Connor, Portland, OR (US); Maneet Khaira, Vancouver, WA (US); Kauhi Kukulukahalelaupilionaali’i Hookano, San Francisco, CA (US)

(73) Assignee: Backbone Labs, Inc., Vancouver, WA (US)

(21) Appl. No.: 18/202,755

(22) Filed: May 26, 2023

(51) Int. Cl. A63F 13/358; A63F 13/44

(52) U.S. Cl. CPC A63F 13/358; A63F 13/44

(57) ABSTRACT

Some cloud gaming and other remote game environments require a user to wait in a queue before playing a game. During this time, the user may be concerned that they will lose their place in the queue if they close the window displaying the game to do another task on the computing device. If the user decides to do something away from the computing device while waiting in the queue, it is possible that the user will be unaware when they progress out of the queue and miss their opportunity to play the game. This can be a frustrating experience for the user. The embodiments presented herein can be used to address this situation.

### BACKGROUND

A controller can be used with a computing device to select and/or interact with content using user input elements on the controller. The content can be locally-stored on the computing device and/or streamed from a remote device. For example, the controller can be a game controller used to play a game that is native to the computing device and/or to play a game that is streamed from a cloud streaming service to a browser of the computing device.

### BRIEF DESCRIPTION OF THE DRAWINGS

FIG. 1 is a diagram of an example computing environment of an embodiment.

FIG. 2 is an illustration of an example controller and computing device of an embodiment.

FIG. 3 is a diagram of an example computing environment of an embodiment.

FIG. 4 is a diagram of an example network of an embodiment.

FIG. 5 is a flow chart of an example cloud game queuing method of an embodiment.

FIG. 6 is a screen shot of an embodiment that provides an indication of a user's place in a queue.

FIG. 7 is a screen shot of an embodiment that provides an updated indication of a user's place in a queue.

FIG. 8 is a screen shot of an embodiment that informs a user that the user progressed out of a queue.

FIG. 9 is a user queue flow diagram of an embodiment.

FIG. 10 is a flow diagram of an embodiment for user queue progression.

FIG. 11 is a flow diagram of an embodiment for user queue completion.

FIG. 12 is a screen shot of an embodiment that provides launch education.

FIG. 13 is a screen shot of an embodiment that prompts a user to enable notifications.

FIG. 14 is a screen shot of an embodiment that notifies a user that a game window can be minimized.

FIG. 15 is a screen shot of an embodiment that notifies a user that the user can use other applications while the user is waiting in a queue.

FIG. 16 is a screen shot of an embodiment that displays a game tile showing a last state of a game.

FIG. 17 is a screen shot of an embodiment that notifies a user that there is a wait for a server.

FIG. 18 is a screen shot of an embodiment that shows how long a rig has been running.

FIG. 19 is a screen shot of an embodiment that notifies a user that the user has progressed out of a queue.

FIG. 20 is a screen shot of an embodiment that notifies a user that a game is still running.

FIG. 21 is a screen shot of an embodiment that notifies a user that the user can only play one game at a time.

FIG. 22 is a screen shot of an embodiment that present a user with an option to quit a game.

FIG. 23 is a screen shot of an embodiment that notifies a user that the game has quit.

FIG. 24 is a screen shot of an embodiment that displays a set of notifications.

FIG. 25 is a screen shot of an embodiment that notifies a user of the user's position in a queue.

FIG. 26 is a screen shot of an embodiment that notifies a user of how long a game was running.

FIG. 27 is a screen shot of an embodiment that notifies a user of a wait for a server.

FIG. 28 is a screen shot of an embodiment that notifies a user that a game is ready.

FIG. 29 is a screen shot of an embodiment that notifies a user that a game has quit running.

FIG. 30 is a screen shot of an embodiment that notifies a user that a game has quit running.

FIG. 31 is a screen shot of an embodiment that shows surfacing of a game icon.

FIGS. 32A-B are screen shots of an embodiment related to offering an upsell to skip a queue.

The drawings are for purposes of illustrating example embodiments, but it should be understood that the claims are not limited to the arrangements and instrumentality shown in the drawings.

### DETAILED DESCRIPTION

### Introduction

As will be described in more detail below, some cloud gaming and other remote game environments require a user to wait in a queue before playing a game. During this time, the user may be concerned that they will lose their place in the queue if they close the window displaying the game to do another task on the computing device. If the user decides to do another activity on their computing device while waiting in the queue, it is possible that the user will be unaware when they progress out of the queue and miss their opportunity to play the game. This can be a frustrating experience for the user.

The following embodiments provide ways for a user to multitask on the computing device while waiting in one or more cloud game queues. In one embodiment, a computing device is provided comprising one or more processors, a non-transitory computer-readable medium, and program instructions stored on the non-transitory computer-readable medium. The program instructions, when executed by the one or more processors, cause the one or more processors to perform functions comprising: displaying a browser on the computing device to launch a game on a cloud streaming service in response to a request from a user, wherein the cloud streaming service places the user in a queue prior to allowing the user to play the game; receiving, from a server, additional program instructions that, when executed by the one or more processors, further cause the one or more processors to perform functions comprising obtaining information about the user's wait in the queue; receiving a signal from a game controller in communication with the computing device indicating actuation of a user input element of the game controller; and in response to receiving the signal from the game controller: hiding a display of the browser without closing the browser so the user's position in the queue is not lost; obtaining information about the user's wait time in the queue using the additional program instructions received from the server; and displaying the information about the user's wait in the queue.

In another embodiment, a method is provided that is performed in a computing device coupled with a mobile game controller. The method comprises: launching a game from a remote game service, wherein a user is placed in a queue prior to being able to play the game; receiving a signal from the mobile game controller; and in response to receiving the signal from the game controller; removing a display of the game without causing the user's position in the queue to be lost; obtaining information about the user's wait in the queue; and displaying the information about the user's wait in the queue.

In yet another embodiment, a non-transitory computer-readable medium is provided that stores program instructions that, when executed by one or more processors in a server, cause the one or more processors to perform functions comprising: receiving, from a computing device, an identification of a game that a user of the computing device is attempting to play, wherein the game places the user in a queue prior to allowing the user to play the game; and sending, to the computing device, additional program instructions that, when executed by one or more processors in the computing device, cause the one or more processors in the computing device to perform functions comprising obtaining information about the user's wait in the queue.

Other embodiments could include a platform where the queue is to enter the gameplay state of the platform and then the user selects a game from there

Other embodiments are provided, and any of the embodiments described herein can be used alone or in combination with one another.

Before turning to a description of example implementations, the following section provides an overview of an exemplary computing environment. It should be understood that these are merely examples and other implementations can be used. Accordingly, none of the details presented herein should be read into the claims unless expressly recited therein.

### Overview of an Exemplary Computing Environment

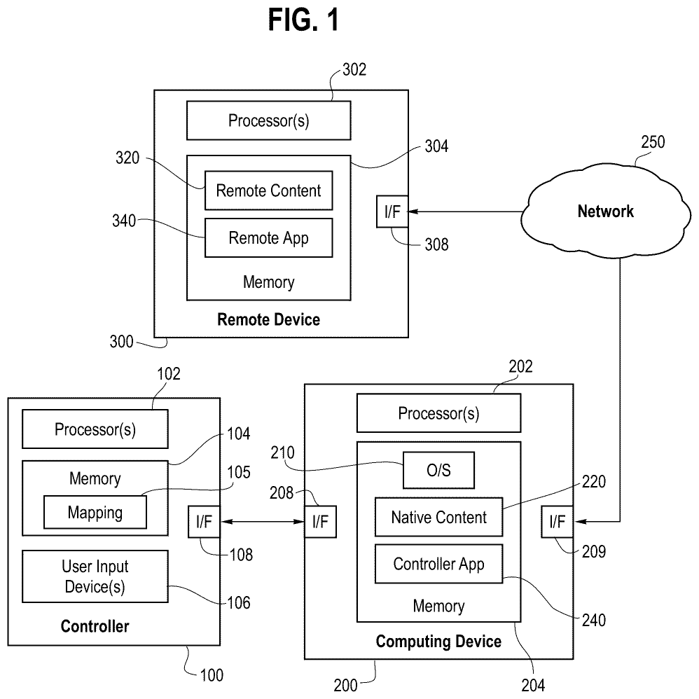

Turning now to the drawings, FIG. 1 is an illustration of a computing environment of an embodiment. As shown in FIG. 1, this environment comprises a user controller 100 (e.g., a game controller), a computing device 200 (e.g., a mobile phone), and a remote device 300 (e.g., a server). The user controller 100 and computing device 200 are in communication with each other via respective wired or wireless interfaces 108, 208. Likewise, the computing device 200 and the remote device 300 are in communication with each other via wired or wireless interfaces 209, 308. As used herein, “in communication with” can mean in direct communication with or in indirect communication with via one or more components, which may or may not be mentioned herein. For example, in the embodiment shown in FIG. 1, the computing device 200 and the remote device 300 are in communication with each other via a network 250 (e.g., the Internet, a local area network, a peer-to-peer wireless mesh, etc.). However, in other embodiments, the computing device 200 and the remote device 300 can communicate with each other in the absence of a network. Also, as used herein, the remote device 300 is “remote” in the sense that it is physically separate from the computing device 200 in some fashion. In many implementations, the physical distance is relatively great, such as when the remote device 300 is located in another town, state, or country. In other implementations, the physical distance may be relatively short, such as when the remote device 300 is in the same room or building as the computing device 200. Also, the term “remote device” can refer to a single remote device or multiple remote devices.

Other embodiments could be an online offline mode, i.e. offline sync or coordinating via clocks. Queueing may not necessarily be of computing resources but for access to content

As shown in FIG. 1, in this embodiment, the controller 100 comprises one or more processors 102, a memory 104, and one or more user input devices (or elements) 106. The user input devices 106 can take any suitable form, such as, but not limited to, a button, a joystick, a switch, a knob, a touch-sensitive screen/pad, a microphone for audio input (e.g., to capture a voice command or sound), a camera for video input (e.g., to capture a hand or facial gesture), etc. To be clear, as used herein a “user input device” refers to a control surface and not to the entire system or parent device on which user input devices are placed.

Generally speaking, the controller 100 can be used by a user in the selection and (passive or active) consumption of content (e.g., playing a game, watching a video, listing to audio, reading text, navigating a displayed user interface, etc.) presented using the computing device 200 in some fashion. The controller 100 may be referred to based on the content with which it is being used. For example, the controller 100 can be referred to as a game controller when it is being used to play a game. And if the controller 100 is being used to play a game on a mobile device, such as a phone or tablet (as opposed to a relatively-stationary game console), the controller 100 can be referred to as a mobile game controller. However, the same controller 100 may also be used to control the playback of non-game content, such as video or audio. Accordingly, a specific use should not be read into the term “controller” unless expressly stated.

The computing device 200 can also take any suitable form, such as, but not limited to, a mobile device (e.g., a phone, tablet, laptop, watch, eyewear, headset, etc.) or a relatively more-stationary device (e.g., a desktop computer, a set-top box, a gaming console, etc.). In the embodiment shown in FIG. 1, the computing device 200 comprises one or more processors 202 and a memory 204. In this particular embodiment, the memory 204 stores computer-readable program code for an operating system (O/S) 210 (e.g., iOS or Android), native content 220, and an application configured for use with the controller 100 (“controller app”) 240. This application 240 will sometimes be referred to herein as the client platform operating service or system. Exemplary functions of this application 240 will be described herein. Also, as used herein, “native content” refers to content that is at least partially stored in the computing device 200. For example, native content can be wholly stored on the computing device; or native content can be stored partially on the computing device 20 and partially on one or more remote devices 300 or some other device or set of devices.

The remote device 300 also comprises one or more processors 302 and memory units 304 storing remote content 320 and an application (“app”) 340 (which is sometimes referred to herein as the remote platform operating service or system) that can be used to communicate with the controller app 240 or another entity on the computing device 200.

It should be understood that more or fewer components than what are shown in FIG. 1 can be used. For example, the computing device 200 can have one or more user input device(s) (e.g., a touchscreen, buttons, switches, etc.), as well as a display (e.g., integrated with a touchscreen). Further, while the components in the controller 100, computing device 200, and remote device 300 are all shown in respective single boxes in FIG. 1, implying integration in respective single devices, it should be understood that the components can be located in multiple devices. For example, the processor 302 and memory 304 in the remote device 300 can be distributed over multiple devices, such as when the processor 302 is a server and the memory 304 is a remote storage unit. As used, the remote device 300 can also refer to multiple remote devices that are in communication with the computing device 200. Other variations for any of the devices 100, 200, 300 are possible.

The memory 104, 204, 304 in these various devices 100, 200, 300 can take any suitable form and will sometimes be referred to herein as a non-transitory computer-readable storage medium. The memory can store computer-readable program code having program instructions that, when executed by one or more processors, cause the one or more processors to perform certain functions.

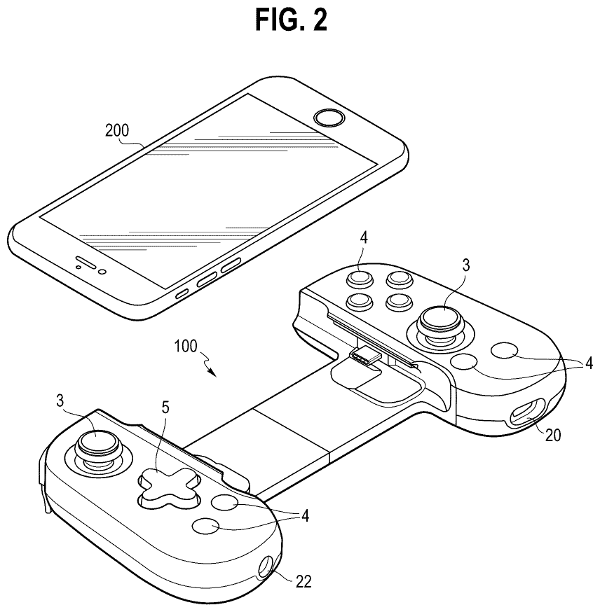

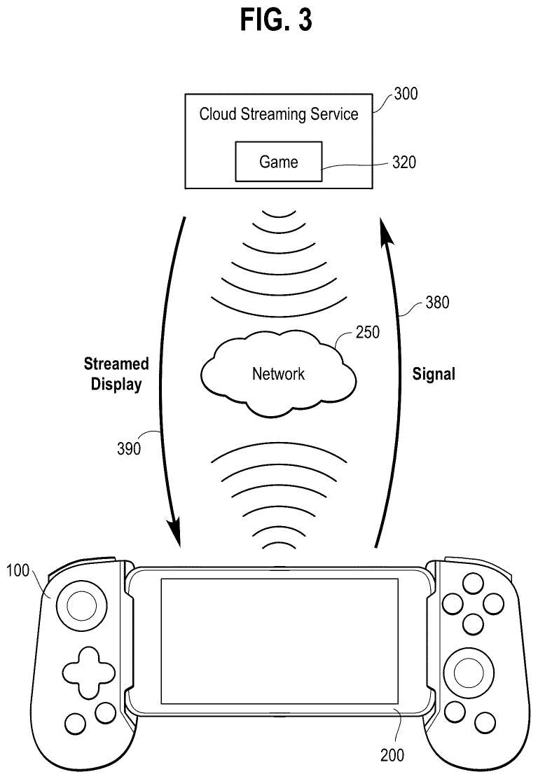

As mentioned above, the controller 100, computing device 200, and remote device 300 can take any suitable form. For purposes of describing one particular implementation of an embodiment, the controller 100 in this example takes the form of a handheld game controller, the computing device 200 takes the form of a mobile phone or tablet, and the remote device 300 takes the form of a cloud gaming system. This example is shown in FIGS. 2 and 3. Again, this is just one example, and other implementations can be used. Further, as mentioned above, a game is just one example of content that can be consumed, and the controller 100 can be used with other types of content (e.g., video, audio, text). So, the details presented herein should not be read into the claims unless expressly recited therein.

Turning first to FIG. 2, FIG. 2 shows an example handheld game controller 100 and mobile phone 200 of an embodiment. This game controller 100 has a number of user input devices, such as joysticks 3, buttons 4, and toggle switches 5. In this example, the game controller 100 takes the form of a retractable device, which, when in an extended position, is able to accept the mobile phone 200. A male communication plug on the controller 100 mates with a female communication port on the computing device 200 to place the controller 100 and computing device 200 in communication with one another. The controller 100 in this embodiment also has a pass-through charging port 20 that allows the computing device 200 to have its battery charged and a headphone jack 22. In other embodiments, the controller 100 can connect to the computing device 200 through other means such as pairing wirelessly to the phone 200. Again, this is just an example, and other types of controllers can be used, such as those that do not fit around a mobile device.

As shown in FIG. 3, in this embodiment, the controller 100 can be used to play a game that is locally stored on the computing device 200 (a “native game” 220) or a game 320 that is playable via a network 250 on a cloud streaming service 300 (e.g., a cloud gaming service). In this example embodiment, remote gameplay, based on input from the game controller 100, the computing device 200 sends signals 380 to the cloud streaming service 300 and receives display data 390 back. In one embodiment, a browser on the computing device 200 is used to send and receive the signals 380, 390 to stream the game 320 to the user. There can be multiple variants of remote game play. One embodiment includes a host device, such a game console, PC, or other computing device not actively being controlled that can stream a game to the active computing device, such as a smartphone, from a host device (e.g., game console or PC) that a user can access remotely via their smartphone. Another embodiment includes a cloud streaming service (which can be streamed from a data center), such as Xbox Game Pass, Amazon Luna, or other service, that can be streamed to the active computing device.

Other embodiments could be a digital version of content that is physically owned by the user. This would allow users to stream or play a digital version of their content.

In one embodiment, the controller app 240 can facilitate the selection of a game (or other content). For example, the controller app 240 can display a user interface (e.g., on a display of the computing device 200 or on another display). The controller app 240 can also receive user input from the controller 100 to navigate and engage with content, for example, to browse for, select, and launch a game from a displayed list of games. In this example, once the game is launched, input from the game controller 100 can be provided directly to the game or indirectly to the game through the controller app 240. As will be discussed in more detail below, the controller app 240 can enhance the standard experience offered on a computing device by extending functionality and providing enhanced interface capabilities in addition to the inherent interface of the computing device itself. For example, in some embodiments, the controller app 240 assigns a function to one or more of the user input devices on the controller 100 based on the particular content being consumed.

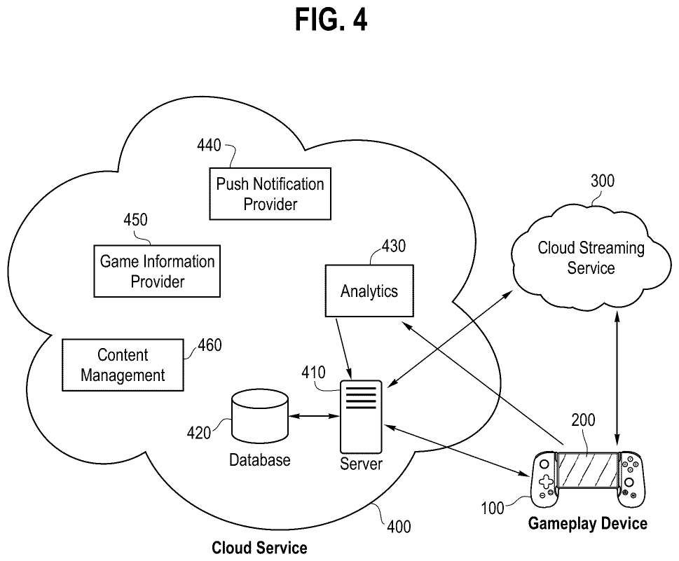

As shown in FIG. 4, in addition to being in communication with the remote device/cloud streaming service 300, the gameplay device (i.e., the controller 100 and the computing device 200) can be in communication with a cloud service 400. In one embodiment, data is not publishing to the cloud service 300, but data is consumed from it (i.e., there may or may not be the bidirectional communication). The combination of the functionality provided by the controller app 240 on the computing device 200 and the functionality provided by the cloud service 400 will sometimes be referred to herein as a “platform operating service.” In one embodiment, the functionality of the cloud service 400 can be provided by the same or related entity that provides the controller 240 (e.g., the manufacturer of the controller 100 or an entity related to the manufacturer of the controller 100). Other arrangements are possible. The functionality can be used to facilitate operation of the controller 100 and its use to select and consume content (e.g., play a game) from the cloud streaming service 300.

The cloud service 400 can comprise any suitable component or functionality. In the example shown in FIG. 4, the cloud service 400 comprises a server 410, a database 420, an analytics element 430, a push notification provider 440, a game information provider 450, and a content management element 460. The server 410 can comprise one or more processors and a non-transitory medium that stores program instructions that, when executed by the one or more processors, provide various functions, some of which are described below. The server 410 or other component of the cloud service 400 can contain a memory that stores additional program instructions that can be sent to the computing device 200, which will also be described below.

Additional details and features, at least some of which can be used with these embodiments, can found in U.S. provisional patent application No. 63/422,797, filed Nov. 4, 2022, which is hereby incorporated by reference.

### Examples of Cloud Game Queuing

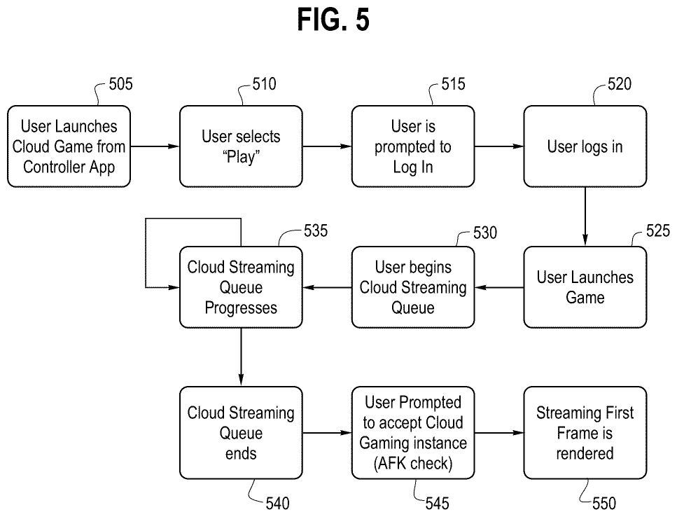

As mentioned above, in some situations, the gameplay device (e.g., the mobile game controller 100 and the computing device 200) is used to select and play a game from the cloud streaming service 300. FIG. 5 is a flow chart that illustrates this process. As shown in FIG. 5, the user starts by launching the cloud game from the controller app 240 on the computing device 100 (act 505) and selecting “play” (act 510). This can cause a browser to launch in the controller app 240, and a user interface element such as but not limited to a web page from the cloud streaming service 300 is displayed in the browser and prompts the user to log-in (act 515). After the user logs-in (act 520), the game may start, with the streaming game content being provided in the browser launched inside of the controller app 240. However, in other situations, there may be a wait to play the game. For example, the cloud streaming service 300 may limit the number of users who can play the game at any given time based on the computing resources that are allocated for the game. Without such a limitation, there may be unintended delays or pauses in the game that can adversely affect the user's game play experience.

In other embodiments, the content can be launched via Bluetooth streaming or other media streaming methods.

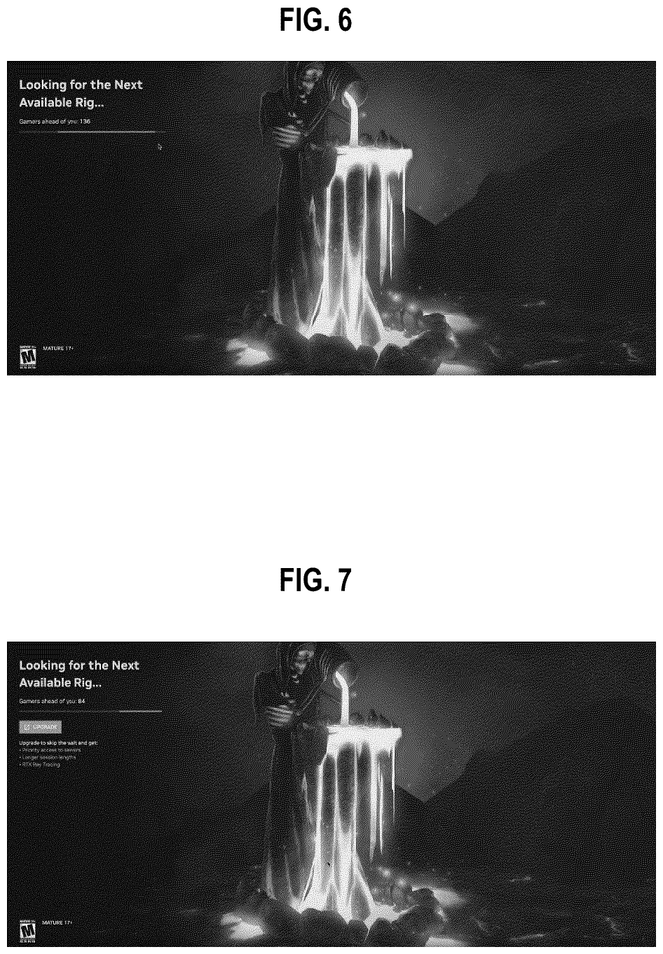

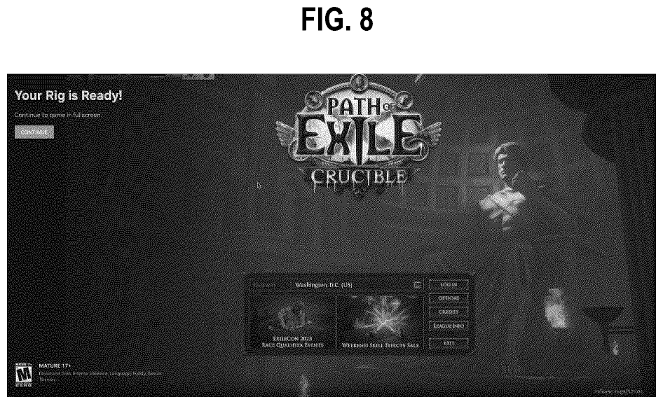

So, if the selected cloud game does not have the capacity to allow the user to play the game, the user is entered into a queue (act 530). The web page displayed in the browser can provide the user with an indication of the user's place in the queue (see FIG. 6) or a schedule time to access the content. This indication can take any suitable form, such as, but not limited to, a number that indicates the user's position in the queue (e.g., “you are the 10th person in the queue) or an estimated amount of time before the user can play the game (e.g., “your wait time is approximates 10 minutes), etc. As the user moves up in the queue (e.g., as players leave the queue to enter the game or exit the queue by closing their browser) (act 535), the cloud streaming service 300 can provide an updated web page that shows the user's updated position in the queue (see FIG. 7). When the user progresses out of the queue (act 540), the user can be prompted to satisfy an “away from keyboard (AFK)” check to being playing the game (act 545) (see FIG. 8). This is done because it is possible that, due to the wait to play the game, the user may place their gameplay device down to do something else and may not be near their gameplay device when they are eventually allowed to play the game. The AFK check ensures that the user is actually there to play the game, thereby avoiding the possibility of allowing an “idle player” to take up a space that could have otherwise been offered to another user in the queue. After the user satisfies the AFK check, the browser in the controller app 240 displays the first frame streamed from the cloud streaming service 400, and the user begins to play the game (act 550).

There are headwinds that suggest queue times will be the norm for cloud gaming services. As cloud gaming becomes more developed and adopted, demand will require these services to make users wait to play if they do not pay a premium to avoid queueing or to advance in the queue. For example, one cloud streaming service (GeForce Now) already has queue times for its free tier where a user might need to wait over an hour to play, and another cloud streaming service (Xbox Cloud Gaming) turned on its queue time system during a prior Christmas season.

Cloud game queuing can be a negative experience for a user, especially when wait times are unknown and highly unpredictable. Also, a user may not feel a sense of security that they can do other activities inside or outside of the controller app 240 without disconnecting their cloud gaming session, especially if there is not a clear and easy way to minimize and exit the game while waiting in a queue. To address this problem, in one embodiment, when a user is waiting in a cloud gaming queue, the user can press a button (or, more generally, activate a user input element) on the game controller 100 to allow the user to keep their place in the cloud game queue while allowing the user to perform other activities (“multi-task”) on the gameplay device (e.g., play another game, user another application on the computing device 200, etc.). While performing another activity, the computing device 200 can display an indication of the user's status in the queue (e.g., the user's position in the queue, an estimated amount of time before the user can play the game, etc.). The display of this indication can be dynamic to reflect the user's progress in the queue.

This indication can take any suitable form. For example, the computing device can minimize the display of the browser communicating with the cloud streaming service 400 (e.g., by placing the browser in the smaller display area of a picture-in-picture display). This way, the user can perform another activity in the larger display area while still being able to see the browser for the cloud streaming service 400 in the smaller display area. That can give the user assurance that they are still in the queue and can also provide information to the user about the wait to play the game.

More information about picture-in-picture and alternatives, which can be used alone or in combination with the embodiments presented herein, can be found in U.S. patent application Ser. No. 18/076,172, filed Dec. 6, 2022, which is hereby incorporated by reference.

In some situations, it may be difficult for the user to read the queue status information from this smaller version of the browser. Also, while relatively small, the smaller version of the browser still takes up real estate on the display, which can interfere with the user's view of the rest of the display. This is especially true if the user is waiting in more than one queue. So, in another embodiment, the browser (or, more generally, the display area) can be minimized or otherwise not displayed to the user while still keeping the browser running in the background (e.g., in response pushing a button or otherwise activating a user input element on the controller 100), so the user's place in the queue is not lost. Even though the browser is not displayed, information about the user's wait in the queue can be displayed (e.g., using a pop-up notification, a persistent indicator, a dynamic island, a live-activities display, etc.). As used herein, the phrase “the user's wait in the queue” can refer to the user's position in the queue, an estimated time remaining in the queue, and/or other information, such as, but not limited to, historical wait times, other users' wait times, what other users are in line, etc.

The information about the user's wait can be obtained in any suitable way. For example, the computing device 200 can use an application program interface (API) to communicate with the cloud streaming service 300 to ask for and obtain the information. As another example, the computing device 200 can use an algorithm to estimate the information based on other information. For instance, the computing device 200 can observe a rate of progress in the queue and use that as the basis for the estimate (e.g., the user moved from position 500 to position 490 in the queue in one minute, so the user's estimated wait time is 50 minutes).

As another example, the information about the user's wait in the queue can be scraped from a web page that is received from the cloud streaming service 300 (the web page may not be displayed to the user if the browser is not in the foreground and displayed to the user). In one embodiment, special program instructions (e.g., JavaScript code) are received from the server 410 in the cloud service 400 to enable the computing device 200 to do the scraping. A memory in the server 410 or elsewhere in the cloud service 400 can store a plurality of sets of program instructions for a variety of games, and the server 410 can choose which set to send to the computing device 200 (e.g., as a single payload or as part of an event-based payload) based on an identification of the game that was launched on the cloud streaming service 300. Also, as the cloud streaming service 300 may change the display location of the queue information, the server 410 can dynamically update (on-the-fly) the program instructions to account for the change and send updated program instructions to the computing device 200. When the user eventually progresses out of the queue, the computing device 200 can re-display the browser or display area (e.g., automatically or after prompting the user for confirmation) to allow the user to play the game.

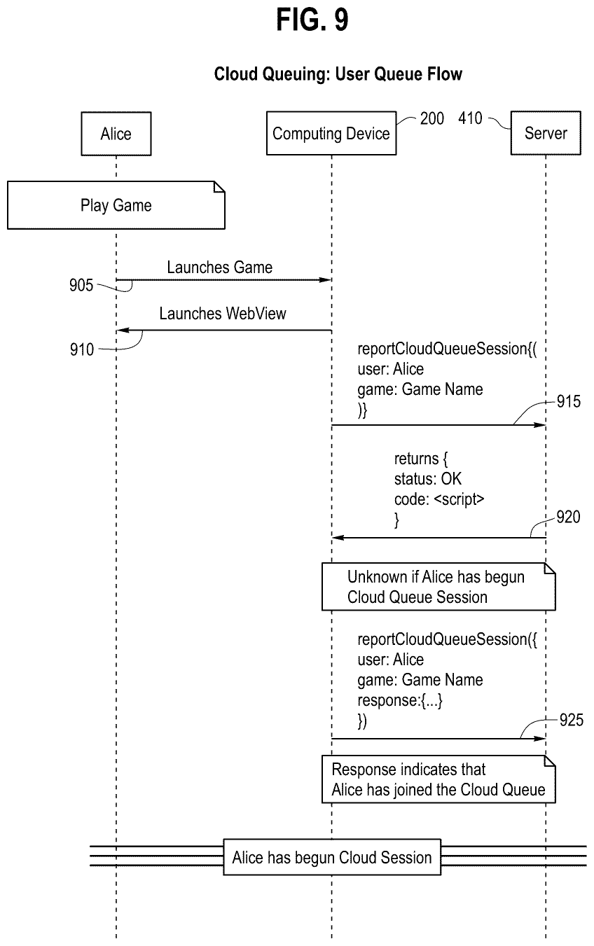

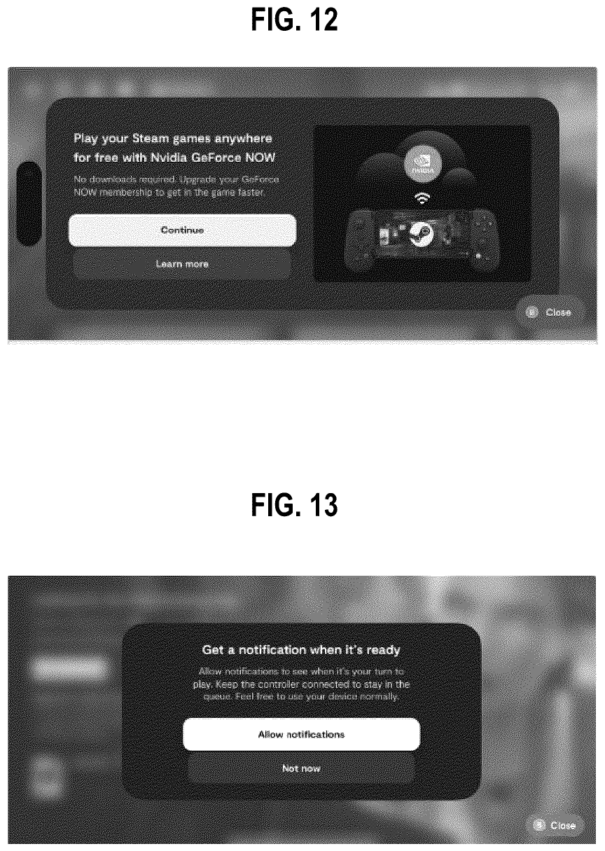

The flow charts of FIGS. 9-11 and the screen shots of FIGS. 12-32B will now be described to provide an illustration of one example implementation of these embodiments. It should be understood that this is merely an example and that other implementations can be used. As such, none of the details presented herein should be read into the claims unless expressly recited therein.

Turning first to FIG. 9, FIG. 9 is a flow diagram illustrating the beginning of the queue flow process. In this example, the user (Alice) wants to use the computing device 200 to play a game on the cloud streaming service 300 (not shown in FIG. 9 to simplify the drawing) using the game controller 100. When the user launches the game (act 905), a browser is launched and displays a webpage to the user (act 910), and the computing device 200 informs the server 410 that the user launched the game (act 915). With this information, the server 410 selects the appropriate program instructions that the computing device 200 may need to scrape the information about the user's wait in the queue from a web page received from the cloud gaming streaming 300 and sends the program instructions to the computing device 200 (act 920). In this example, the program instructions are sent even before the user enters the queue (in other examples, the program instructions can be sent after the user enters the queue). After the user enters the queue, the computing device 200 informs the server 410 (act 925).

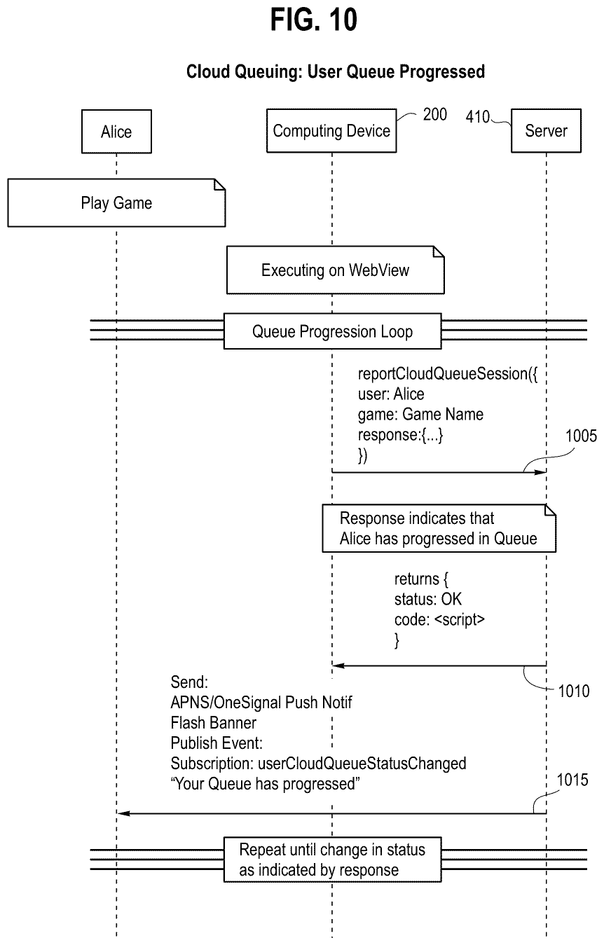

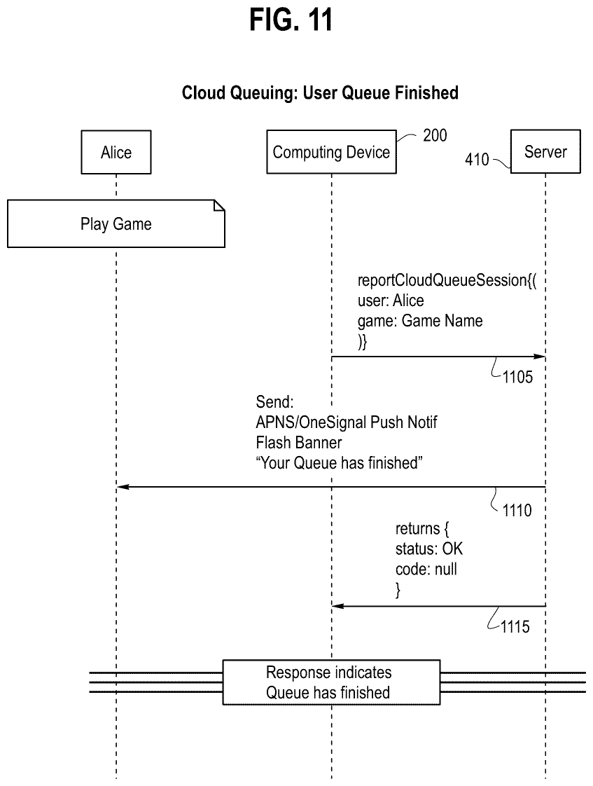

As shown in FIG. 10, in this example, as the computing device 200 determines that the user is making progress in the queue (e.g., using the program instructions previously received from the server 410), the computing device 100 informs the server 410 of the progress. In this example, the server 410 sends potentially-updated program instructions to scrape the information about the user's wait in the queue from a web page received from the cloud streaming service 300 (act 1005). This is done in case the cloud streaming service 300 changes where the queue information is displayed, which may render the previously-sent instructions out-of-date. The server 410 also informs the user, via the computing device 200, of the information about the user's wait in the queue (act 1015). As shown in FIG. 11, this continues (e.g., with the computing device 200 pinging the cloud streaming service 300 for new web pages to scrape) until the computing device 200 informs the server 410 that the user has progressed out of the queue (act 1105). At that time, the server 410 informs the user, via the computing device 200, that the queue has finished (act 1110) and sends a completion message to the computing device 200 (act 1115).

It should be noted that while the above example was described in terms of the user entering one game/platforms's queue, these embodiments can be used when the user is in multiple queues. In that situation, the user's progress in all the queues can be displayed individually or in a combined fashion.

Turning now to the screen shots of FIGS. 12-32B, these screenshots illustrate a possible flow of one implementation of these embodiments. As mentioned above, it should be understood that this is merely an example and that other implementations can be used. As such, none of the details presented herein should be read into the claims unless expressly recited therein.

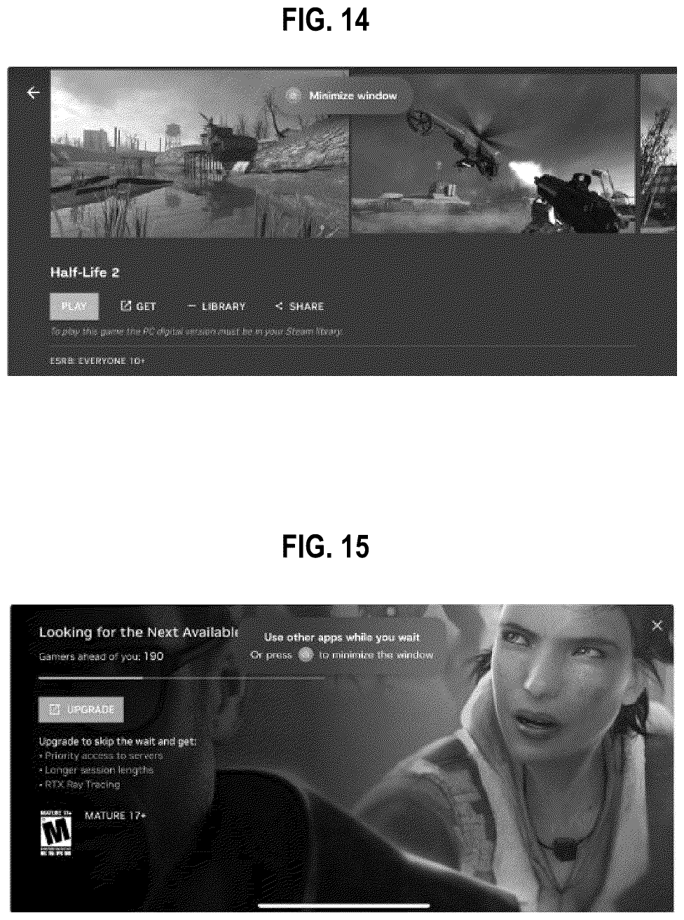

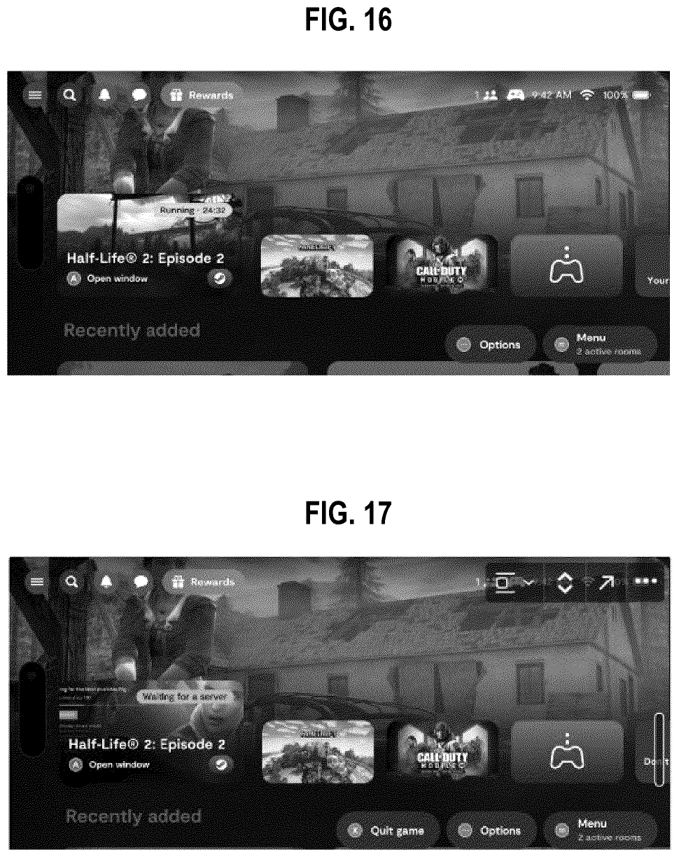

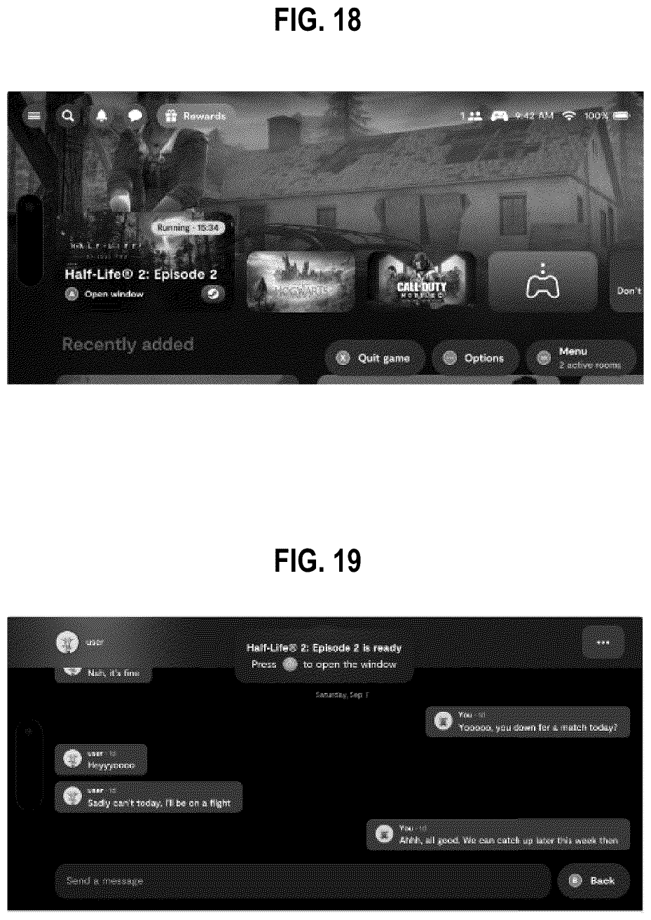

Starting with FIG. 12, the first time a user launches a game, an “education modal” screen can be displayed that informs a user of an upgrade option to expedite or avoid queuing. Next (FIG. 13), the user is asked to turn on notifications, as notifications are used in this example to present information about the user's wait in the queue. Then (FIG. 14), the user is presented with the option to play a selected game and is also informed of the option to minimize the window by pushing a button on the game controller 100. After the user launches the game, a web page is received from the cloud streaming service 300 and displayed to the user showing the user's position in the queue (FIG. 15). This screen also displays an in-app notification letting the user know that they can multitask (e.g., “Use other apps while you wait”). At this point, if the user backs out of an active cloud stream game, the user is brought back to an integrated dashboard display, where the displayed tile for the game in the dashboard is a screenshot of the last state the user saw before backing out (FIG. 16). If the user backs out while in the queue, the screen can also display the state (e.g., “waiting for a server”) (FIG. 17). If the user backs out while in an active stream, the screen can show how long the rig has been running (FIG. 18). If showing the time is not possible, the screen can just display the text “Running.” Also, the user can be prevented from being kicked out of their current cloud gaming session due to membership restrictions on session length.

As shown in FIG. 19, if the user moves off of an active cloud stream game tile, a persistent game indicator can appear at the top of the screen. This indicator can stay pinned to the top of the screen until the user opens the web view, and the indicator can disappear if the user scrolls back to the active cloud game. Color coding can also be used (e.g., display an orange indicator when the game is queuing, and display a green indicator when the rig is active). Pressing a button on the game controller 100 can animate the active cloud stream game back to the foreground. If the last game was not the active cloud stream game (e.g., if the last game was a native game stored in the computing device 200), pressing the button on the game controller 100 can go back to the native game. Also, tapping the persistent indicator can animate the active cloud stream game back to the foreground.

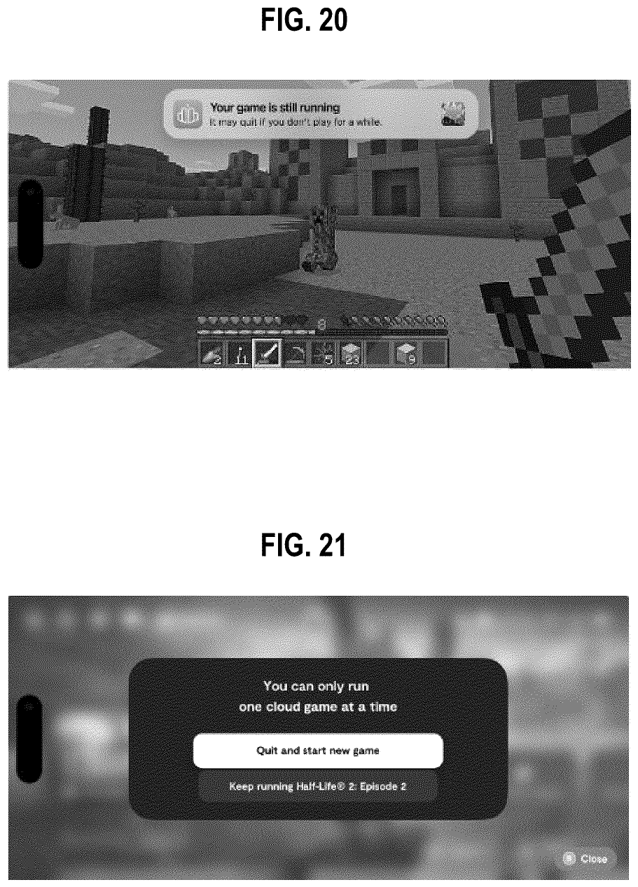

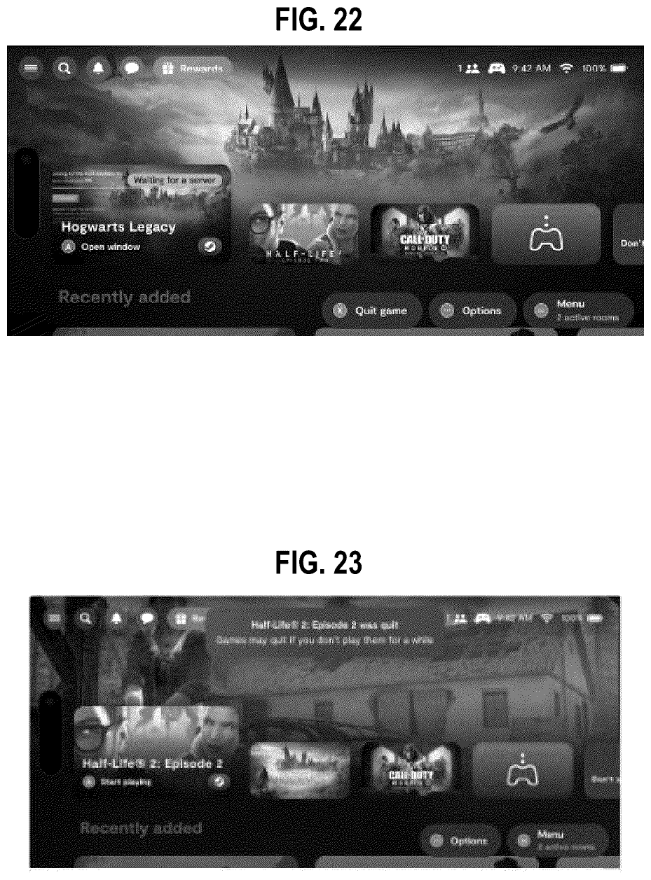

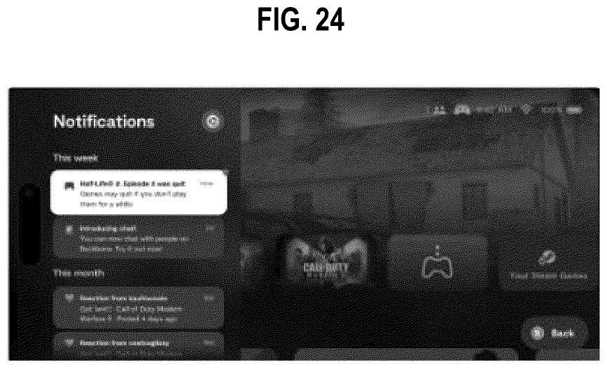

As shown in FIG. 20, if the user switches to a native game or other content on the device while playing an active cloud stream (not in queue), they can receive an in-app notification that their game is still running. Additionally, as shown in FIG. 21, if the user tries to switch to another cloud game, a screen can appear to warn the user that they can only have one active stream at a time, if there is such a restriction. Further, as shown in FIG. 22, the user can be able to quit an active cloud game stream while they are queuing or in an active rig. Also, as shown in FIGS. 23 and 24, if the user's active game rig quits based on inactivity, they can receive an in-app notification and a notification center message that their game quit.

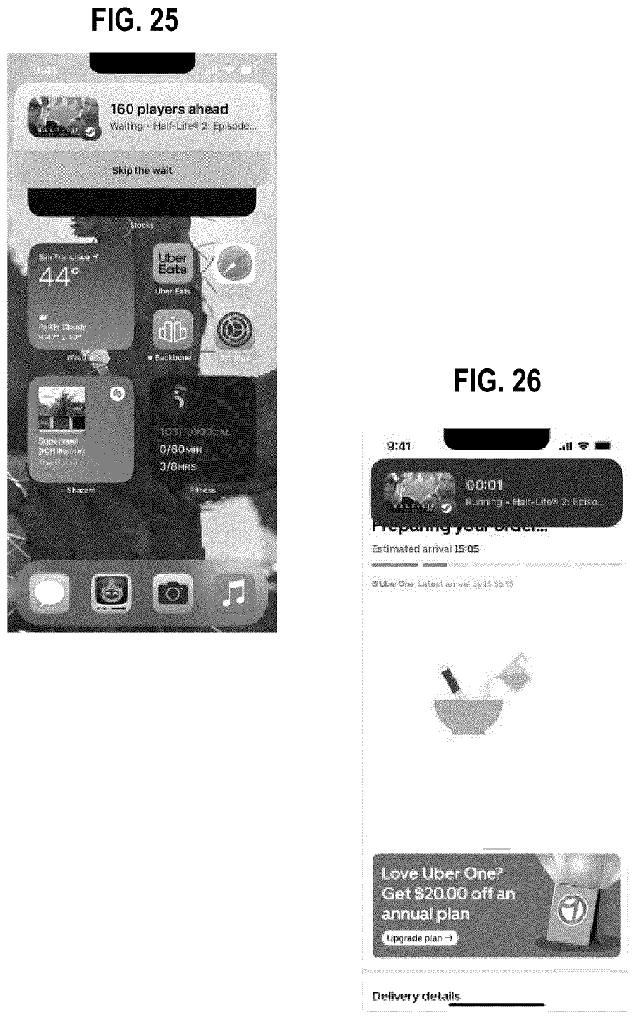

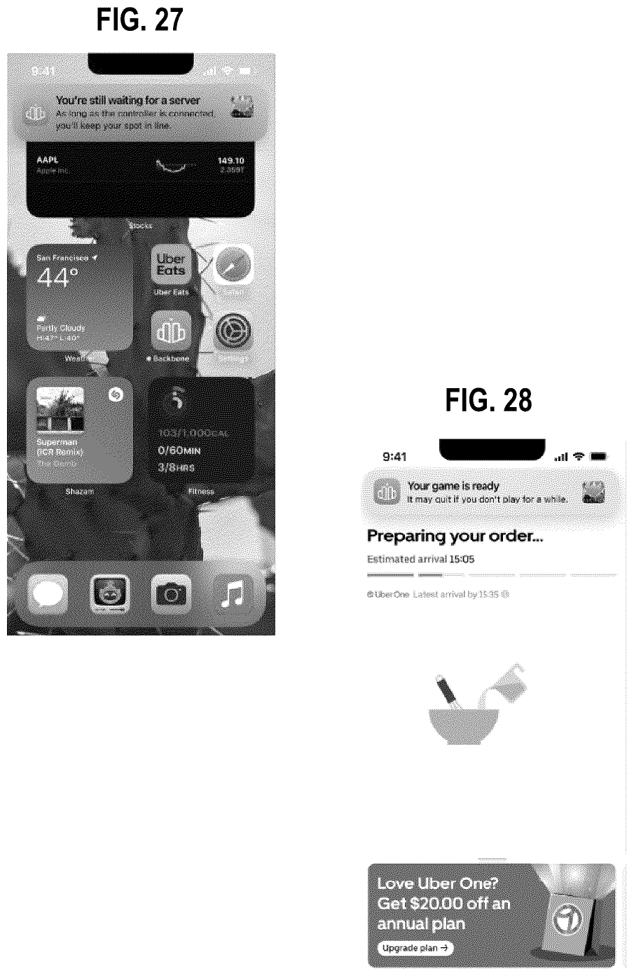

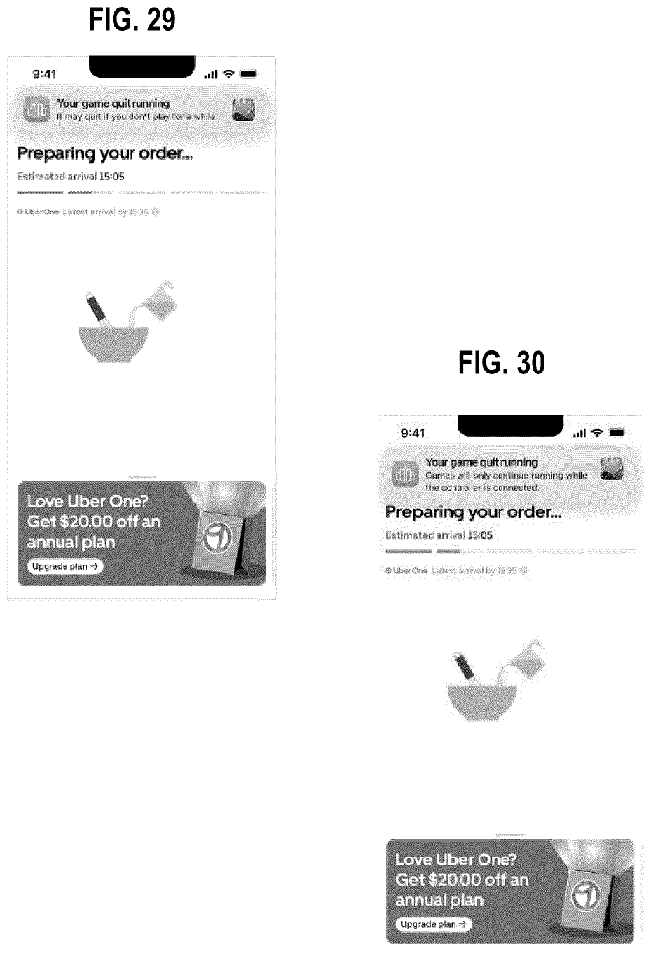

As mentioned above, information about a user's wait in the queue can be displayed in any suitable manner. In the example shown in FIG. 25, the information is displayed in a live activity notification. So, if the user minimizes their cloud gaming browser while in a cloud gaming queue, the computing device 200 can display a live activity notification with how many users are ahead of them in line. Also, as shown in FIG. 26, if the user minimizes their cloud gaming browser while in a cloud gaming session, the computing device 200 can display a live activity notification with how long the rig has been running. Additionally, as shown in FIG. 27, if the user backgrounds the controller app 240 while in a cloud game queue, they can receive a push notification that the queue is in progress and that they will keep their spot in line. When the user is in multiple queues, only one of these notifications can be sent per queue, so the user would not receive another notification unless they started queueing for another game. Once the user's active cloud stream game queue is ready, they can receive a push notification that their game is ready (see FIG. 28). If the user's active game rig quit based on inactivity, they can receive a push notification (see FIG. 29). Also, if the user's active game rig quit because the game closed due to the controller 100 not being connected, they can receive a push notification (see FIG. 30).

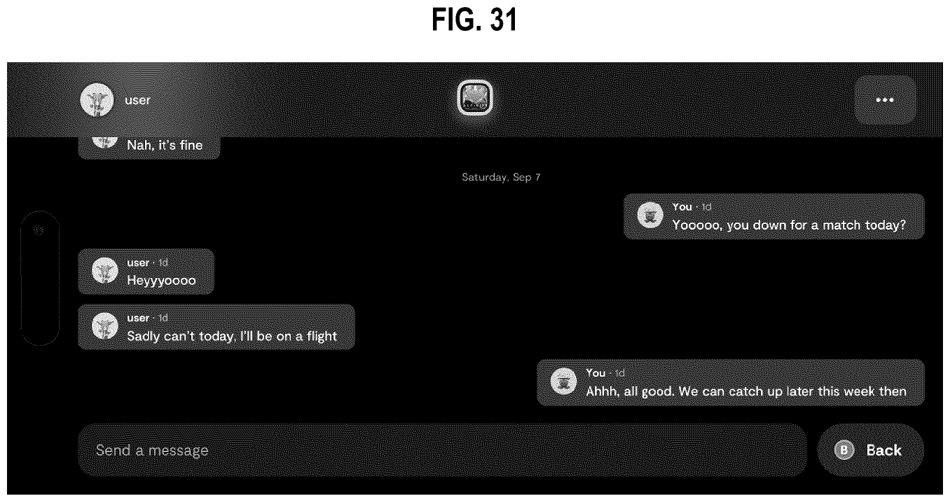

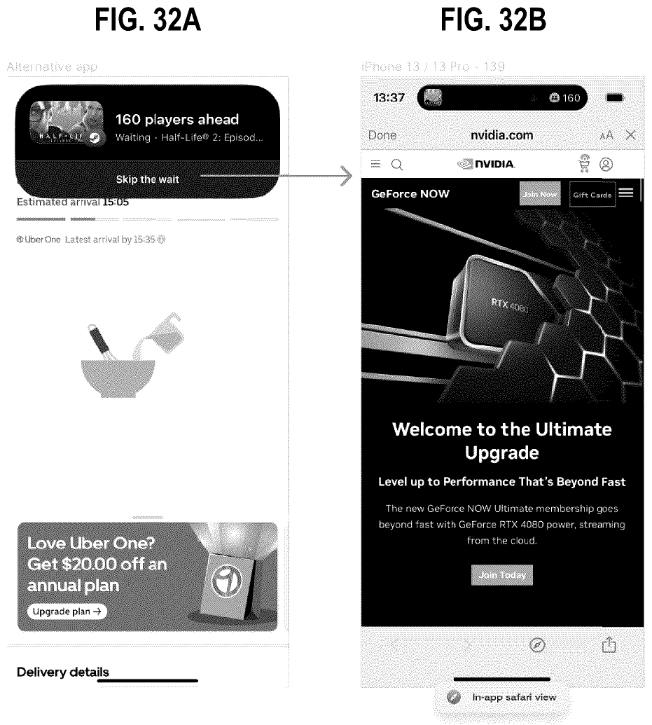

Turning now to FIG. 31, FIG. 31 shows a game icon that is displayed (surfaced) to let the user know which game they are queuing up for at the moment. This icon is a persistent reminder to the user. Also, FIGS. 32A-B show that the user can be presented with an upsell option to allow the user to progress in the queue (e.g., to move ahead in the queue or to skip the queue altogether). This option can be presented in a dynamic island/live activity component.

There are many alternatives that can be used with these embodiments. For example, in one alternative, program instructions received from the server 410 can, when executed, cause the computing device 200 to determine which state the user is currently in and retrieve specific information that the server 410 needs in order to make the next decision. Within iOS and Android, there exists facilities for WebViews, operating service level functionality, that allow injection of arbitrary JavaScript code. JavaScript code can be evaluated on the page, and information can be retrieved about the user's current state without the utilization of APIs from the aforementioned Cloud Game Platform. The JavaScript code payload sent by the server 410 can ascertain at which point the user is in and when a user is in a games catalog page, a cloud gaming waiting state, or a cloud gaming instance ready state, for example. This information can then be communicated to the server 410, which can determine the next actions to take.

The JavaScript code sent by the server 410 can collect all pertinent information to where the user's current progress is. The current progress of the user can be determined by the various factors, including the HTML on the page, cookies, cache, and local/session storage, all of which can be processed by the Javascript on the client and then information relating to cloud session state can be sent to the server. This information can include, for example, queue position, queue estimated wait time, and current game the user is playing. In another embodiment all the relevant information is uploaded to the server for making the determination. In one embodiment, a single payload is used. With a single payload paradigm, the server 410 can use a link to a Javascript payload which is loaded by the Client to determine both objectives stated above. The advantage of this is simplicity and speed. The information gathered can be both event-based and page specific, and this would allow the computing device 200 to load the user script onto the page then continuously call the functions created.

In another embodiment, the information processed by the embedded script on the client can be sent to the server 410 for processing. The updated information can then be sent back to the client to update various graphical interfaces.

In contrast, with an event-based payload, the two objectives are decoupled, with one endpoint used to detect the current state of the page the user is on and another endpoint used to retrieve the information from the page. One advantage to this approach is the focus on attending to problems with scraping (since the objectives are decoupled, problems with scraping may be more-easily detected). However, the single payload approach can improve developer experience and focus, as well as be segmented by platform, thereby keeping all related code in a single file, which may be simpler over time.

There are many alternatives that can be used with these embodiments. For example, instead of using these embodiments when a user is in a queue waiting to play a game, these embodiments can be use to keep an active session running if the user needs to multi-task during game play (e.g., as part of cloud session management). That is, these embodiments can be expanded to include the situation where a user is playing a game and not only when queuing for a game. As another example, these embodiments can be used on any shared server or even a local server that prepares a stream.

### CONCLUSION

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A computing device comprising:
one or more processors;
a non-transitory computer-readable medium; and
program instructions stored on the non-transitory computer-readable medium that, when executed by the one or more processors, cause the one or more processors to perform functions comprising:
displaying a browser on the computing device to launch a game on a cloud streaming service in response to a request from a user, wherein the cloud streaming service places the user in a queue prior to allowing the user to play the game;
receiving, from a server, additional program instructions that, when executed by the one or more processors, further cause the one or more processors to perform functions comprising obtaining information about the user's wait in the queue;
receiving a signal from a game controller in communication with the computing device indicating actuation of a user input element of the game controller; and
in response to receiving the signal from the game controller:
hiding a display of the browser without closing the browser so the user's position in the queue is not lost;
obtaining information about the user's wait in the queue using the additional program instructions received from the server; and
displaying the information about the user's wait in the queue.

2. The computing device of claim 1, wherein the program instructions, when executed by the one or more processors, further cause the one or more processors to perform functions comprising:
receiving a dynamically-updated version of the additional program instructions from the server to account for a change in how the cloud streaming service presents the information about the user's wait in the queue.

3. The computing device of claim 1, wherein the program instructions, when executed by the one or more processors, further cause the one or more processors to perform functions comprising:
informing the server of an identification of the game that was launched on the cloud streaming service, wherein the server is configured to use the identification of the game to select the additional program instructions to send to the computing device.

4. The computing device of claim 1, wherein the information about the user's wait in the queue comprises the user's position in the queue and/or an estimated remaining time in the queue.

5. The computing device of claim 1, wherein the information about the user's wait in the queue is displayed using a notification, a persistent indicator, an icon, a dynamic island, and/or a live activity notification.

6. The computing device of claim 1, wherein the additional program instructions comprise embedded code.

7. The computing device of claim 1, wherein the additional program instructions are part of a single payload.

8. The computing device of claim 1, wherein the additional program instructions are part of an event-based payload.

9. The computing device of claim 1, wherein the program instructions, when executed by the one or more processors, further cause the one or more processors to perform functions comprising:
in response to the user progressing out of the queue, re-displaying the browser to allow the user to play the game.

10. A method comprising:
performing by a computing device coupled with a mobile game controller:
launching a game from a remote game service, wherein a user is placed in a queue prior to being able to play the game;
receiving a signal from the mobile game controller; and
in response to receiving the signal from the game controller:
removing a display of the game without causing the user's position in the queue to be lost;
obtaining information about the user's wait in the queue; and
displaying the information about the user's wait in the queue.

11. The method of claim 10, wherein the information about the user's wait in the queue is obtained by scraping the information from a web page received from the remote game service.

12. The method of claim 11, further comprising:
receiving, from a server, program instructions for scraping the information from the web page.

13. The method of claim 10, wherein the information about the user's wait in the queue is obtained using an application program interface.

14. The method of claim 10, wherein the information about the user's wait in the queue is obtained by using an algorithm to estimate the information.

15. The method of claim 10, further comprising performing the method for a plurality of queues.

16. The method of claim 10, further comprising:
providing an upsell option to allow the user to skip the queue.

17. A non-transitory computer-readable medium storing program instructions that, when executed by one or more processors in a server, cause the one or more processors to perform functions comprising:
receiving, from a computing device, an identification of a game that a user of the computing device is attempting to play, wherein the game places the user in a queue prior to allowing the user to play the game; and
sending, to the computing device, additional program instructions that, when executed by one or more processors in the computing device, cause the one or more processors in the computing device to perform functions comprising obtaining information about the user's wait in the queue.

18. The non-transitory computer-readable medium of claim 17, wherein the program instructions, when executed by the one or more processors in the server, further cause the one or more processors to perform functions comprising:
sending, to the computing device, a dynamically-updated version of the additional program instructions to account for a change in how the game or platform presents the information about the user's wait in the queue.

19. The non-transitory computer-readable medium of claim 17, wherein the program instructions, when executed by the one or more processors in the server, further cause the one or more processors to perform functions comprising:
receiving, from the computing device, the information about the user's wait in the queue; and
sending, to the computing device, a notification to display to the user regarding the information about the user's wait in the queue.

20. The non-transitory computer-readable medium of claim 17, wherein the additional program instructions comprise embedded code.
